(19) United States
(12) Patent Application Publication
(10) Pub. No.: US 2005/0216352 A1
(43) Pub. Date: Sep. 29, 2005

(54) System and method for performing an availability check

(76) Inventors: Madan Mohan, Bangalore (IN); Sunil Lal, Bangalore (IN); Balaji Jayaraman, Bangalore (IN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/790,694

(22) Filed: Mar. 3, 2004

(51) Int. Cl. G06F 17/60; G06F 3/00

(52) U.S. Cl. 705/22

(57) ABSTRACT

Principles of the present invention provide a method of performing an availability check on a mobile device. The method includes receiving an item number and a requested quantity of the item number. The method creates an availability query with parameters comprising the item number and the quantity, connects to a principal computing platform, and sends the availability query to the principal computing platform. The method receives a query result from the principal computing platform, the query result indicates the availability of the item number at the requested quantity.

### TECHNICAL FIELD

This invention relates generally to methods and systems for synchronizing data, and more specifically to methods and systems for performing an availability check of goods through a synchronization process.

### BACKGROUND

Increasingly, companies operating around the globe need to make information available across a wide expanse of territory. For example, a sales person in Cairo, Egypt using a laptop computer may need to access information from a central server located in Chicago, Ill. Thus, information has to be made available across both territorial and computer system boundaries quickly to provide efficient decision support. Companies, such as SAP AG, provide systems empowering global businesses to conduct their operations across a dispersed landscape of computer systems and countries.

One type of decision support tool required by these global entities, particularly those engaged in sales activities, is whether and when goods are available for purchase and delivery to customers. Availability of goods, known in the industry as “Available-to-Promise” or ATP or an availability check, is a key decision support tool for sales people in the field who have limited access to computers. Sales people use availability checks to check on the availability of goods for customer delivery. An availability check is generally an online check to ensure that a company can provide the requested product at the requested time in the quantity requested by the customer.

Systems, such as SAP R/3 and SAP APO, provide services known as ATP checks, whereby a sales person performs an online check from her computer or personal digital assistant (“PDA”) to a back office system to determine the availability of goods. The back office system may be a warehouse system that maintains an inventory of goods in stock or may be a production planning system that maintains projections of future goods and their allocations.

As mentioned above, ATP checks are typically performed online from the sales person's computer to check the availability of product. For example, a sales person may place a laptop computer online at a customer's site and perform an ATP check by having the laptop query the remotely located back office system. Such systems tether the sales person to his laptop and require the laptop to be online. But, the reality is that a sales person will often be moving about a customer's place of business, engaging the customer in dialog and sales, and not have the ability to stay constantly bound to his online laptop.

### SUMMARY

A system consistent with the present invention includes a microprocessor and memory coupled to the microprocessor. The microprocessor is operable to: receive an item number and a requested quantity of the item number; create an availability query with parameters comprising the item number and the quantity; connect to a principal computing platform; send the availability query to the principal computing platform; and receive a query result from the principal computing platform, the query result indicating the availability of the item number at the requested quantity.

A method consistent with the present invention includes: receiving an item number and a requested quantity of the item number; creating an availability query with parameters comprising the item number and the quantity; connecting to a principal computing platform; sending the availability query to the principal computing platform; and receiving a query result from the principal computing platform, the query result indicating the availability of the item number at the requested quantity.

An article of manufacture consistent with the present invention contains instructions for performing an availability check on a mobile device. The instructions are capable of causing a processor to: receive an item number and a requested quantity of the item number; create an availability query with parameters comprising the item number and the quantity; connect to a principal computing platform; send the availability query to the principal computing platform; and receive a query result from the principal computing platform, the query result indicating the availability of the item number at the requested quantity.

A system consistent with the present invention includes a microprocessor and memory coupled to the microprocessor. The microprocessor is operable to: synchronize one or more data items in a backend database with one or more data items in a replica database located at the mobile device; receive an item number and a requested quantity of the item number; create an availability query with parameters comprising the item number and the quantity; apply the availability query to the replica database; and provide a query result, the query result indicating the availability of the item number at the requested quantity.

A method consistent with the present invention includes: synchronizing one or more data items in a backend database with one or more data items in a replica database located at the mobile device; receiving an item number and a requested quantity of the item number; creating an availability query with parameters comprising the item number and the quantity; applying the availability query to the replica database; and providing a query result, the query result indicating the availability of the item number at the requested quantity.

An article of manufacture consistent with the present invention contains instructions for performing an availability check on a mobile device. The instructions are capable of causing a processor to: synchronize one or more data items in a backend database with one or more data items in a replica database located at the mobile device; receive an item number and a requested quantity of the item number; create an availability query with parameters comprising the item number and the quantity; apply the availability query to the replica database; and provide a query result, the query result indicating the availability of the item number at the requested quantity.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is an illustration of a system consistent with the present invention for performing an availability check.

FIG. 2 is a block diagram of hardware components of a principal and auxiliary computing platform consistent with the present invention.

FIG. 3 is a flowchart of a first availability check process consistent with the present invention.

FIG. 4 is a flowchart of a first availability query process consistent with the present invention.

FIG. 5 is a flowchart of a second availability check process consistent with the present invention.

FIG. 6 is an order screen consistent with the present invention.

FIG. 7 is a result screen consistent with the present invention.

### DETAILED DESCRIPTION

The following description refers to the accompanying drawings in which, in the absence of a contrary representation, the same numbers in different drawings represent similar elements. The implementations in the following description do not represent all implementations consistent with the claimed invention. Instead, they are merely some examples of systems and methods consistent with the invention.

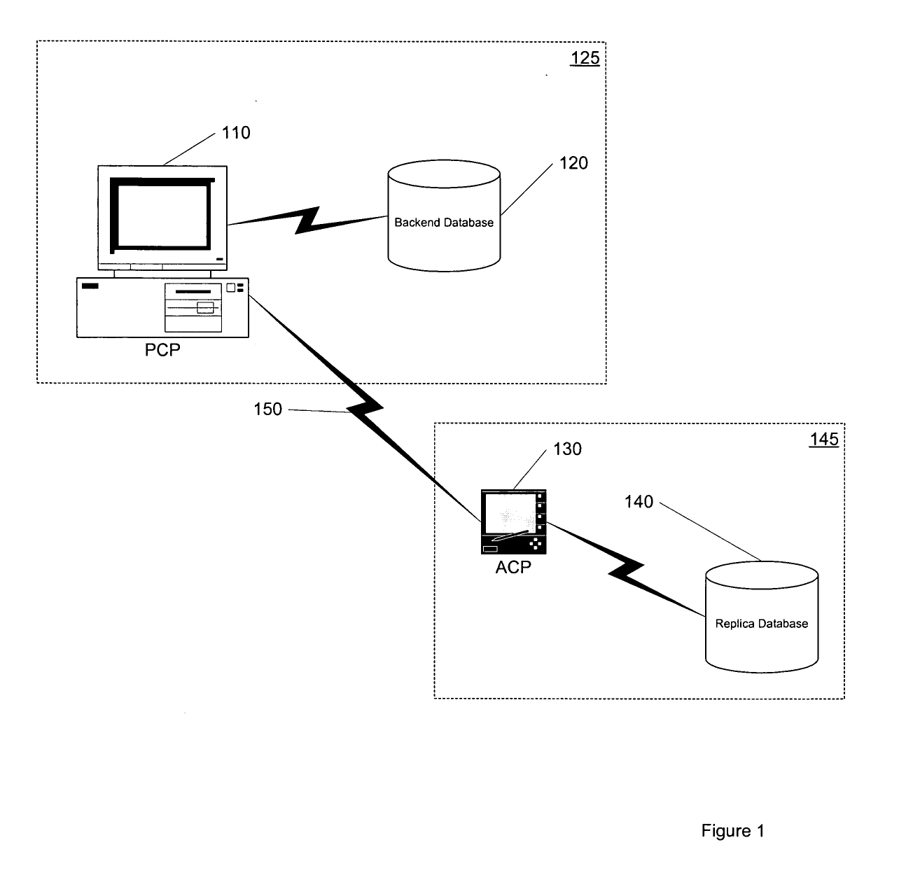

FIG. 1 is an illustration of a system consistent with the present invention for performing an availability check. The system comprises two main components: a backend system 125 and a mobile device 145. Together a principal computing platform (PCP) 110 and a backend database 120 comprise the backend system 125. PCP 110 may be any type of computing platform, such as a desktop, laptop computer, notebook computer, PDA, handheld computer, or pocket computer running applications that interface to data on backend database 120.

Backend systems, such as SAP R/3 (an enterprise resource planning solution) and SAP APO (advanced planning and optimization software), provide ATP checks, among other functions, whereby a sales person performs a check from her computer or personal digital assistant (“PDA”) to the back office system to determine the availability of goods. The back office system may be, for example, a warehouse system that maintains an inventory of goods in stock or may be a production planning system that maintains projections of future goods and their allocations.

An auxiliary computing platform (ACP) 130 and a replica database 140 comprise a mobile device 145. Mobile device 145 provides a portable computing platform for use by, for example, outside sales personnel. ACP 130 may be any type of computing platform running applications that provide an availability check. Examples of ACP 130 include a desktop computer, a laptop computer, a notebook computer, a PDA, a handheld computer, or a pocket computer. ACP 130 accesses the replica database 140 containing a replica of one or more data records found in backend database 120. Replica database 140 may be located on the same platform as ACP 130.

In practice, the availability check consistent with the present invention may be performed on the ACP 130, for example: by an online availability check or an offline availability check. “Online” means that in order to carry out the availability check, the ACP 130 must, for at least a small portion of time during the process of conducting the availability check, be connected to the PCP 110 in order to complete the availability check. “Offline” means that in order to carry out the availability check, the ACP 130 does not need to be online.

In either method, ACP 130 does not have to be always connected to PCP 110, but need only be connected during a synchronization period. In the online availability check, a user enters a quantity and type of product for which he wants to check availability into ACP 130. ACP 130 need not be connected to PCP 110 during this data entry period. Next, ACP 130, during a synchronization period, connects through a communications link 150 to PCP 110. ACP 130 sends an Availability query to PCP 110. PCP 110 queries backend database 120 and returns the results of the Availability query to ACP 130. ACP 130 may then disconnect from the communications link 150 and provide the results to the user. In this online availability check, ACP 130 needs to be online only during the synchronization period. The online availability check permits the user to perform an ATP process with only a brief connection to PCP 110 and uses the actual, current data in the backend database 120 so that it reflects a current picture of production and inventory.

In the second method consistent with the present invention, an offline availability check is performed. At some point in time prior to the availability check, ACP 130 connects through communications link 150 to PCP 110 and synchronizes replica database 140 with the backend database 120. This makes the production and inventory information that resides in backend database 120 available to ACP 130 via the local replica database 140. To perform the offline availability check, the user does not need for ACP 130 to ever be connected to PCP 110. In the offline availability check, a user enters a quantity and type of product for which he wants to check availability into ACP 130. Next, ACP 130 performs an availability query using replica database 140 and returns the results of the Availability query to the user. The offline availability check permits the user to perform an ATP process without the need for any connection to PCP 110; however, the data in the replica database 140 may not reflect the most current picture of production or inventory.

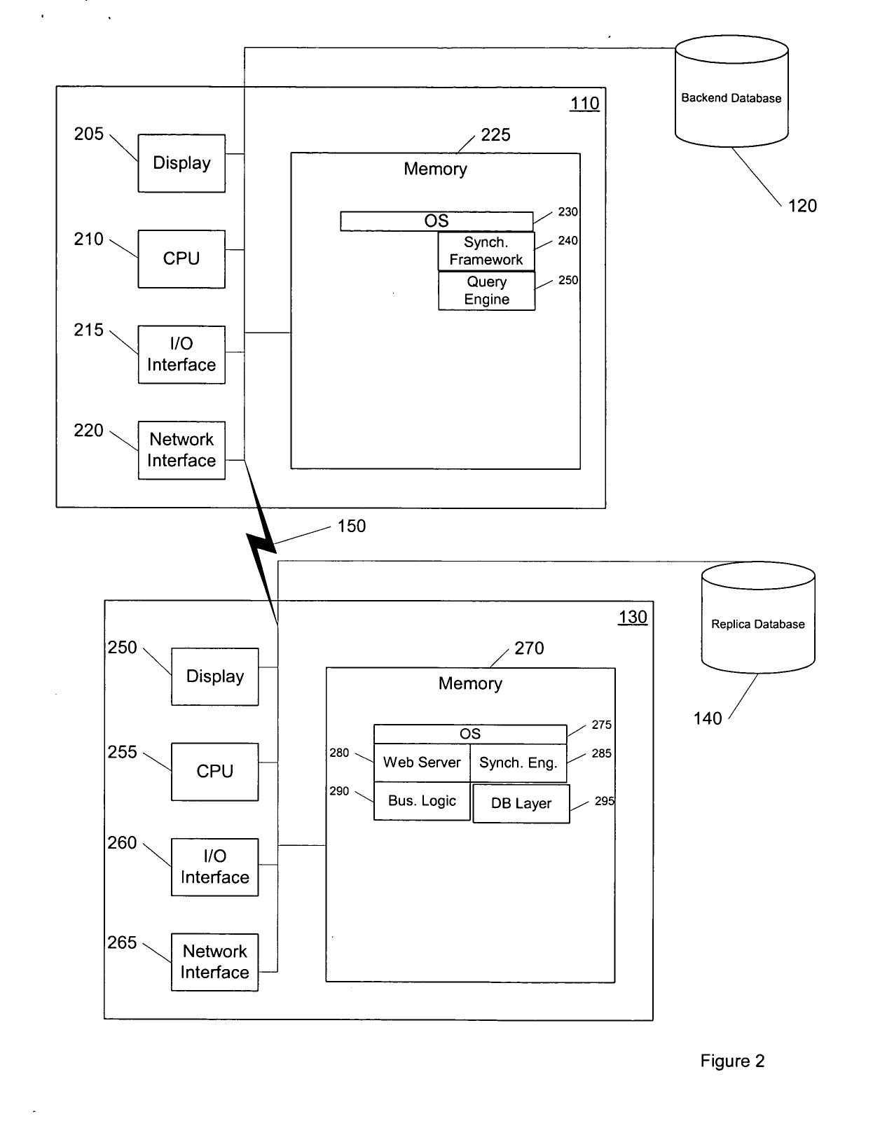

FIG. 2 is a block diagram of components of PCP 110 and ACP 130 consistent with the present invention. Among the many implementation options described above, PCP 110 may be a general-purpose computer running a computer program or a specially constructed computing platform for carrying-out the operations described below. PCP 110, having CPU 210, may receive and respond to availability queries or synchronization requests via I/O interface 215 (which can be any conventional I/O device) or network interface 220 (which can be any conventional interface) by direct connections or other communication links. PCP 110 may also provide a local or remote display 205.

Alternatively, PCP 110 can be part of a network such as a telephone-based network (such as a PBX or POTS), a local area network (LAN), a wide area network (WAN), a dedicated intranet, and/or the Internet. In this way, PCP 110 may be located near or far from ACP 130 and backend database 120.

Memory device 225 may be implemented with various forms of memory or storage devices, such as read-only memory, random access memory, or external devices. Typically, memory device 225 stores instructions forming an operating system 230; a PCP synchronization framework module 240 for providing synchronization functions; and a PCP query engine 250 for receiving and responding to queries from ACP 130.

Similar to PCP 110, ACP 130 may be implemented, among the many options explained above, by a general-purpose computer running the appropriate computer programs stored in the computer, or a specially constructed computing platform. ACP 130 may also be implemented with a wide variety of components including, central processing unit 255, I/O interface 260, network interface 265, and display 205.

As with PCP 110, ACP 130 can communicate via any appropriate type of network, allowing ACP 130 to be located in the same or distant location from PCP 110.

Also, similar to I/O interface 215, I/O interface 260 may be implemented with a wide variety of devices. The same is true of network interface 265 and memory device 270.

Memory device 270 may contain instructions forming: an operating system 275; a web server 280, such as SAP Mobile Engine, for interfacing to a database layer 295; an ACP synchronization engine 285 for synchronizing data between the replica database 140 and the PCP 110; and a business logic process 290 for performing business logic processes received from the PCP 110 after a synchronization.

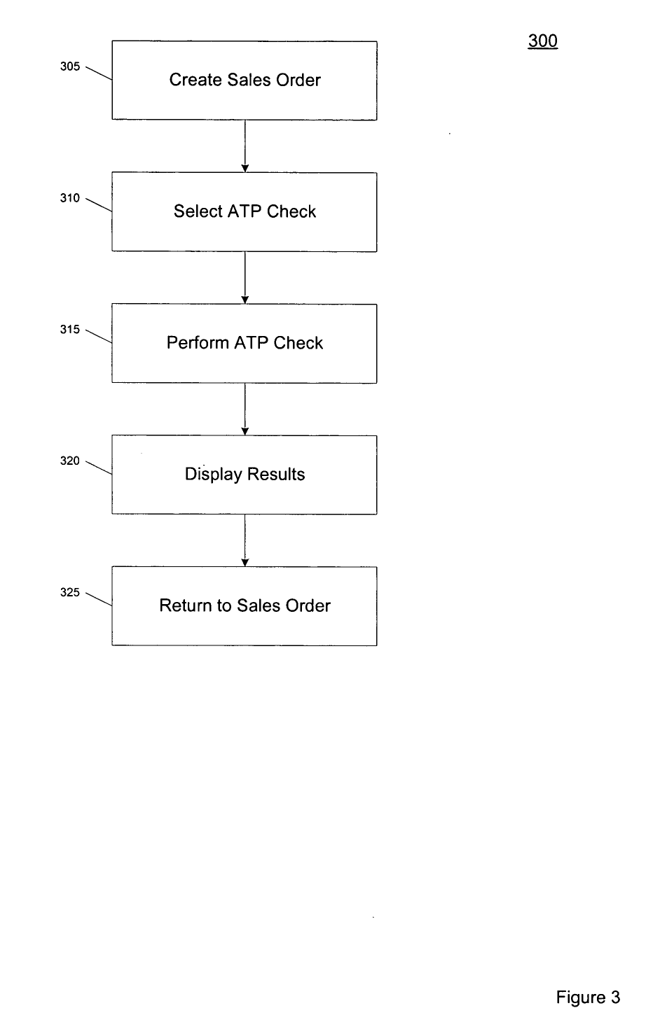

FIGS. 3-5 are flowcharts providing more detail on the availability check processes, which the modules described above, or other modules, can carry out. Those skilled in the art will appreciate that the process flows may be implemented in a variety of fashions. Although these flowcharts illustrate most features of the processes, they may, for purposes of clarity, omit some features in the following text.

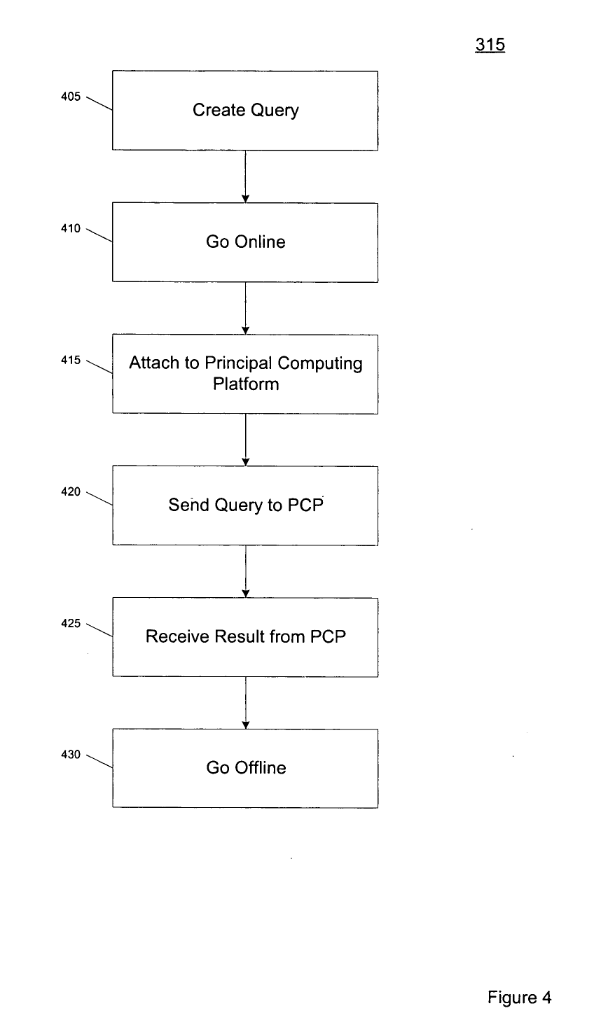

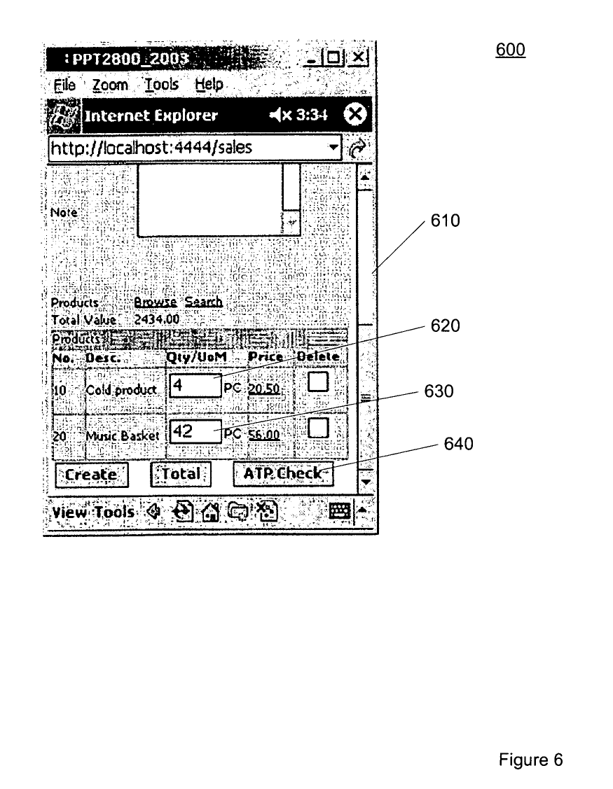

FIG. 3 is a flowchart of a first availability check process 300 consistent with present invention. When a user wishes to perform an availability check, the user creates a sales order (later described with respect to FIG. 6) using the web server module 280 that interfaces to business logic module 290 (stage 305). The user enters an item number and quantity for one or more goods for which he wants an availability check performed. The user then selects that he wishes to perform an availability check (stage 310). The user may initiate this process by, for example, selecting an availability check option on the sales order screen. Web server module 280 engages the synchronization engine 285 to build an appropriate query, connect to PCP 150, send the query to the synchronization framework 240 of PCP 150, and receive the query result from PCP 150 (stage 315). Stage 315 is further explained with respect to FIG. 4.

Following receipt of the query result by the synchronization engine 285, the web server module 280 in conjunction with associated applications displays the result to the user (stage 320). The result may indicate that an order is fully able to be delivered, partially able to be delivered, or not able to be delivered. When the user indicates that he is done viewing the result of the availability check, the web server module 280 returns the user to the order screen (stage 325).

FIG. 4 is a flowchart of a first availability query process 315 consistent with the present invention. The web server module 280 in conjunction with the business logic module 290 creates the availability query based on the entry in the sales order screen (stage 405). The availability query may be set for one or more methods of conducting an availability check, including:
a product availability check, where the quantities in the sales order are checked against the actual inventory;
a product allocation check, where the quantities in the sales order are checked against allocated inventory;
a forecast check, where the quantities in the sales order are checked against forecast production; or
a combination of one or more of the above.

For example, a user may request an availability check on a quantity of 1000 tons of product A. Using a combination availability check, with a product availability check as the first check and a product allocation check as the second check, the user might find the following results. The product availability check might find that 750 tons are available. The product allocation check might find that 500 tons are available for delivery this month, with 250 tons available for delivery next month. Such an availability check would return a result showing the partial ability to fill the result with the more detailed return of 500 tons available this month and 250 tons available next month. The above are only examples of the multiple forms of availability checks that are possible embodiments consistent with the present invention.

At stage 410, ACP 130 goes online to PCP 110 through connection 150 (stage 410). Connection 150 may be, for example, a local area network, a wide area network, a GSM network, a GPRS network, a W-CDMA network, or a UMTS network. The ACP 130 connects to PCP 110 (stage 415). The synchronization engine 285 may temporarily remove from a synchronization queue, which may hold synchronization requests from other applications, any other synchronization requests and send the availability query to PCP 110 (stage 420). PCP 110 executes the availability query on the backend database 120. PCP 110 returns the results of the availability query to the synchronization engine 285 (stage 425). ACP 130 then may go offline (stage 430).

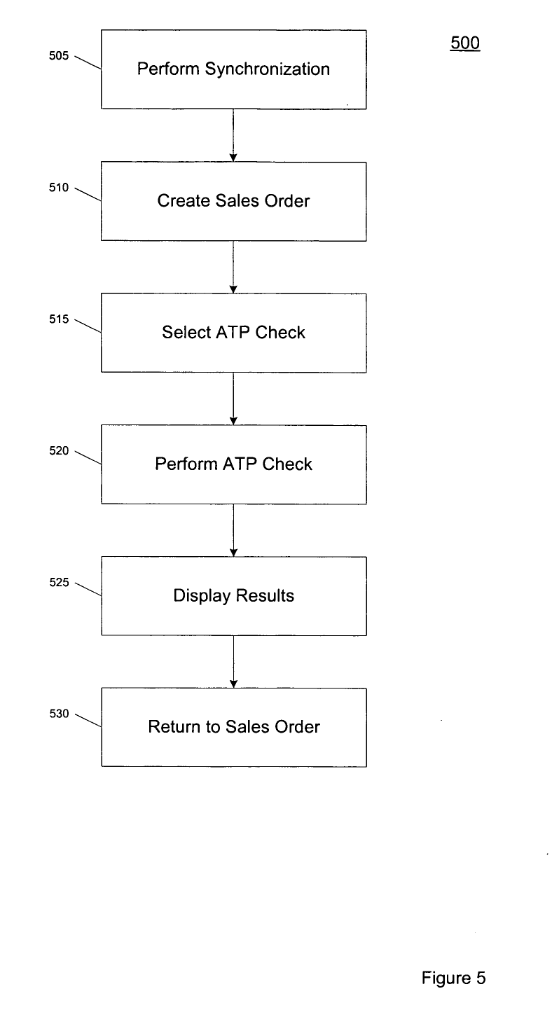

In the first availability check process 300, the ACP 130 temporarily goes online to PCP 110 to conduct the query. In the process described with respect to FIGS. 5 and 6 below, ACP 130 may be synchronized with PCP 110 prior to conducting the availability check, populating the replica database 140 with the relevant data from the backend database 120 that is necessary to conduct the availability check. Thus, ACP 130 does not need to have any online access during an availability check.

FIG. 5 is a flowchart of a second availability check process 500 consistent with present invention. At some point in time prior to the availability check, ACP 130 in communication with PCP 110 synchronizes the contents of the replica database 140 with the contents of the backend database 120 (stage 505). This populates the replica database 120 with the data needed to perform an availability check. The remainder of process 500 is similar to process 300 previously described, except the availability query is conducted on the local replica database 140 instead of requiring an online connection to PCP 110.

When a user wishes to perform an availability check, the user creates a sales order (later described with respect to FIG. 6) using the web server module 280 that interfaces to business logic module 290 (stage 510). The user enters an item number and quantity for one or more goods for which he wants an availability check performed. The user then selects that he wishes to perform an availability check (stage 515). The user may initiate this process by, for example, selecting an availability check option on the sales order screen. Web server module 280 in conjunction with business logic module 290 builds an appropriate query and queries the replica database 140 (stage 520). The queries created are comparable to the query options described with respect to FIG. 4.

Following receipt of the query result, web server 280 displays the result to the user (stage 525). The result may indicate that an order is fully able to be delivered, partially able to be delivered, or not able to be delivered. When the user indicates that he is done viewing the result of the availability check, web server module 280 returns the user to the order screen (stage 530).

FIG. 6 is an order screen 600 consistent with the present invention. Order screen 600 illustrates a screen 610 that a user may use to enter order information prior to requesting an availability check. The user, in this example, enters a quantity, 4, for a first product 620 and a quantity, 42, for a second product. The user may then select the ATP check button 640 to initiate an availability check.

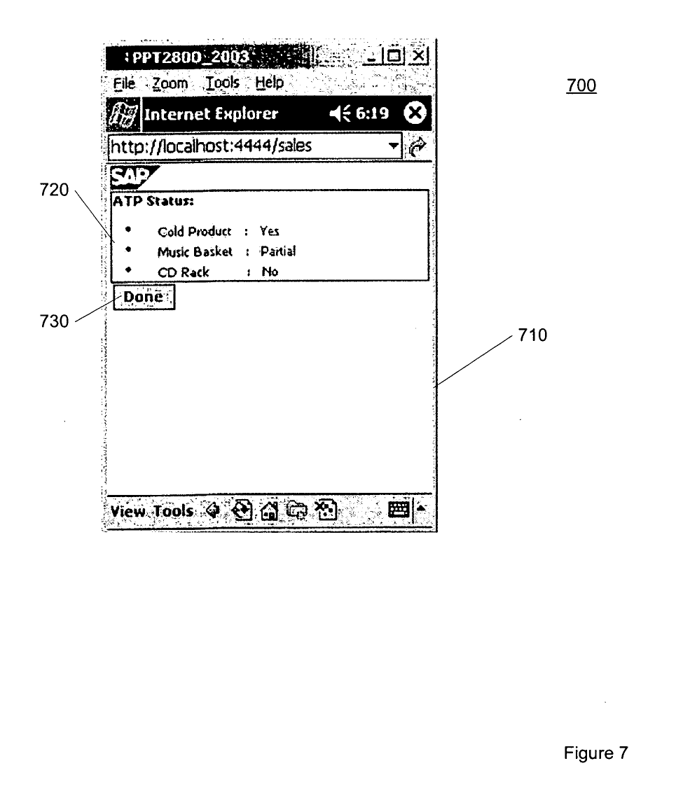

FIG. 7 is a result screen consistent with the present invention. Result screen 700 displays the result of the availability check in screen 710. The status results of the availability check are displayed in a window 720. In this example, the cold product availability indicates that it is fully available for delivery at the requested date and the music basket indicates partial availability at the requested date. When the user has finished viewing the result screen 710, he may select the done button 730 to return to the order screen 600.

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in the appended claims in may other ways, using equivalents and alternatives that do not depart from the scope of the following claims. Moreover, unless indicated to the contrary in the preceding description, none of the components described in the implementations is essential to the invention.

1. A method of performing an availability check on a mobile device, comprising:
receiving an item number and a requested quantity of the item number on an auxiliary computing platform of the mobile device, the auxiliary computing platform disconnected from a principal computing platform;
creating an availability query with parameters comprising the item number and the quantity;
connecting to the principal computing platform;
sending the availability query to the principal computing platform; and
receiving a query result from the principal computing platform, the query result indicating the availability of the item number at the requested quantity.

2. The method of claim 1, further including displaying the query result to a user.

3. The method of claim 1, wherein the availability query is selected from at least one of a product availability check, a product allocation check, and a forecast check.

4. The method of claim 1, wherein the query result indicates at least one of a full, partial, and unavailable availability of the requested quantity.

5. A system for performing an availability check on a mobile device comprising:
a memory; and
a microprocessor coupled to the memory and programmed to:
receive an item number and a requested quantity of the item number on an auxiliary computing platform of the mobile device, the auxiliary computing platform disconnected from a principal computing platform;
create an availability query with parameters comprising the item number and the quantity;
connect to a principal computing platform;
send the availability query to the principal computing platform; and
receive a query result from the principal computing platform, the query result indicating the availability of the item number at the requested quantity.

6. The system of claim 5, wherein the microprocessor is further programmed to display the query result to a user.

7. The system of claim 5, wherein the availability query is selected from at least one of a product availability check, a product allocation check, and a forecast check.

8. The system of claim 5, wherein the query result indicates at least one of a full, partial, or unavailable availability of the requested quantity.

9. An article of manufacture containing instructions for performing an availability check on a mobile device, the instructions being capable of causing a processor to:
receive an item number and a requested quantity of the item number on an auxiliary computing platform of the mobile device, the auxiliary computing platform disconnected from a principal computing platform;
create an availability query with parameters comprising the item number and the quantity;
connect to a principal computing platform;
send the availability query to the principal computing platform; and
receive a query result from the principal computing platform, the query result indicating the availability of the item number at the requested quantity.

10. The article of manufacture of claim 9, wherein the instructions are further capable of causing a processor to display the query result to a user.

11. The article of manufacture of claim 9, wherein the availability query is selected from at least one of a product availability check, a product allocation check, and a forecast check.

12. The article of manufacture of claim 9, wherein the query result indicates at least one of a full, partial, and unavailable availability of the requested quantity.

13. A method of performing an availability check on a mobile device, comprising:
synchronizing one or more data items in a backend database with one or more data items in a replica database located at the mobile device;
receiving an item number and a requested quantity of the item number;
creating an availability query with parameters comprising the item number and the quantity;
applying the availability query to the replica database; and
providing a query result, the query result indicating the availability of the item number at the requested quantity.

14. The method of claim 13, further including displaying the query result to a user.

15. The method of claim 13, wherein the availability query is selected from at least one of a product availability check, a product allocation check, and a forecast check.

16. The method of claim 13, wherein the query result indicates at least one of a full, partial, and unavailable availability of the requested quantity.

17. A system for performing an availability check on a mobile device comprising:
a memory; and
a microprocessor coupled to the memory and programmed to:
synchronize one or more data items in a backend database with one or more data items in a replica database located at the mobile device;
receive an item number and a requested quantity of the item number;
create an availability query with parameters comprising the item number and the quantity;
apply the availability query to the replica database; and
provide a query result, the query result indicating the availability of the item number at the requested quantity.

18. The system of claim 17, wherein the microprocessor is further programmed to display the query result to a user.

19. The system of claim 17, wherein the availability query is selected from at least one of a product availability check, a product allocation check, and a forecast check.

20. The system of claim 17, wherein the query result indicates at least one of a full, partial, and unavailable availability of the requested quantity.

21. An article of manufacture containing instructions for performing an availability check on a mobile device, the instructions being capable of causing a processor to:
synchronize one or more data items in a backend database with one or more data items in a replica database located at the mobile device;
receive an item number and a requested quantity of the item number;
create an availability query with parameters comprising the item number and the quantity;
apply the availability query to the replica database; and
provide a query result, the query result indicating the availability of the item number at the requested quantity.

22. The article of manufacture of claim 21, wherein the instructions are further capable of causing a processor to display the query result to a user.

23. The article of manufacture of claim 21, wherein the availability query is selected from at least one of a product availability check, a product allocation check, and a forecast check.

24. The article of manufacture of claim 21, wherein the query result indicates one of a full, partial, or unavailable availability of the requested quantity.
